(19) United States
(12) Patent Application Publication
(10) Pub. No.: US 2025/0139968 A1
(43) Pub. Date: May 1, 2025

(54) USING INCLUSION ZONES IN VIDEOCONFERENCING

(71) Applicant: Hewlett-Packard Development Company, L.P., Spring, TX (US)

(72) Inventors: Rajen B. Bhatt, Pittsburgh, PA (US); Kishore Venkat Rao Goka, Leander, TX (US); Johnny Gore, Dublin (IE)

(21) Appl. No.: 18/494,670

(22) Filed: Oct. 25, 2023

(51) Int. Cl. G06V 20/40; G06T 7/70; G06V 10/94; G06V 40/10; H04L 65/403; H04N 23/80

(52) U.S. Cl. CPC G06V 20/41; G06T 7/70; G06V 10/945; G06V 40/10; H04N 23/80; G06T 2200/24; G06T 2207/10016; G06T 2207/20092; G06T 2207/30196; H04L 65/403

(57) ABSTRACT

A device, system, and method is provided for using an inclusion zone for a videoconference. The method includes capturing an image of a location, applying a subject detector model to the image to identify room coordinates for each subject detected in the image, and defining an inclusion zone for the location. The inclusion zone is based on a top-down view of the location. The method further includes determining if the room coordinates for each subject are within the inclusion zone, filtering data associated with subjects that are determined to be not within the inclusion zone, and processing data associated with subjects that are determined to be within the inclusion zone.

### BACKGROUND

Various techniques attempt to provide an acoustic fence around a videoconference area to assist with reducing external noise, such as from environmental noise or from other individuals. In one variation, microphones are arranged in the form of a perimeter around the videoconference area and used to detect background or far field noise, which can then be subtracted or used to mute or unmute the primary microphone audio. This technique requires multiple microphones located in various places around the videoconference area. In another variation, an acoustic fence is set to be within an angle of the video-conference camera's centerline or an angle of a sensing microphone array. If the microphone array is located in the camera body, the centerlines of the camera and the microphone array can be matched. This results in an acoustic fence blocking areas outside of an angle of the array centerline, which is generally an angle relating to the camera field of view, and the desired capture angle can be varied manually.

### BRIEF DESCRIPTION OF THE DRAWINGS

FIG. 1 is a top view of an example conference room, according to some aspects of the present disclosure.

FIG. 2 is a schematic isometric view of another example conference room with three individuals located at different coordinate positions in relation to a videoconference camera.

FIG. 3 is a top view of the example conference room of FIG. 2.

FIG. 4 is a schematic isometric view of yet another example conference room with three individuals located at different coordinate positions, according to some examples of the present disclosure.

FIG. 5 is a schematic diagram of a camera and a two-dimensional image plane with an example determination of room coordinates for a head bounding box, according to an example of the present disclosure.

FIG. 6 is a front view of still another example conference room with three individuals located at different coordinate positions, according to some examples of the present disclosure.

FIG. 7 is a schematic isometric view of another example conference room with a single person located at four different coordinate positions in relation to a videoconference camera, according to some examples of the present disclosure.

FIG. 8 is a top view of the example conference room of FIG. 7.

FIG. 9 is an example screen of a GUI for configuring dimensions of a room, according to some examples of the present disclosure.

FIG. 10 is another example screen of a GUI for configuring dimensions of an inclusion zone, according to some examples of the present disclosure

FIG. 11 is a front view of yet another example conference room with four individuals located in a conference room and two individuals located outside of a conference room, according to some examples of the present disclosure

FIG. 12 is a top-down view of the example conference room of FIG. 11 plotted on a room dimension chart.

FIG. 13 is a flowchart of a method of implementing an inclusion zone videoconferencing system in a conference room, according to an example of the present disclosure.

FIG. 14 is a front view of a camera according to an example of the present disclosure.

FIG. 15 is a flowchart of a method of determining image plane coordinates for a detected subject, according to an example of the present disclosure.

FIG. 16 is a schematic of an example codec, according to an example of the present disclosure.

### DETAILED DESCRIPTION

In videoconferencing systems, framing individuals in a videoconference room can be improved by determining the location of individual participants in the room relative to one another or a particular reference point. For example, if Person A is sitting at 2.5 meters from the camera and Person B is sitting at 4 meters from the camera, the ability to detect this location information can enable various advanced framing and tracking experiences. For example, participant location information can be used to define inclusion zones in a camera's field of view (FOV) that excludes peopled located outside of the inclusion zones from being framed and tracked in the videoconference.

When a microphone array of a videoconference system is used in a public place or a large conference room with two or more participants, background sounds, side conversations, or distracting noise may be present in the audio signal that the microphone array records and outputs to other participants in the videoconference. This is particularly true when the background sounds, side conversations, or distracting noises originate from within a field of view (FOV) of a camera used to record visual data for the videoconference system. When the microphone array is being used to capture a user's voice as audio for use in a teleconference, another participant or participants in the conference may hear the background sounds, side conversations, or distracting noise on their respective audio devices or speakers. Further, no industry standard or specification has been developed to reduce unwanted sounds in a videoconferencing system based on the distance from which the unwanted sounds are determined to originate in relation to a videoconferencing camera.

For many applications, it is useful to know the horizontal and vertical location of the participants in the room to provide for a more comprehensive and complete understanding of the videoconference room environment. For example, some techniques operate in only a width, i.e., horizontal, dimension. On the other hand, the ability to determine two-dimensional room parameters, e.g., a width and a depth, for each meeting participant can be enabled by using a depth estimation/detection sensor or computationally intensive machine learning-based monocular depth estimation models, but such approaches impose significant hardware and/or processing costs without providing the accuracy for measuring participant locations. Further, such approaches do not account for the distance each participant is from a camera, or the effect of lens distortion on detection techniques.

For example, some techniques attempt to incorporate filters or boundaries onto an image captured by a camera to limit unwanted sounds from being transmitted to a far end of a videoconference. However, such techniques require multiple microphones and/or do not account for a person's distance from the camera or the effect of lens distortion on the image when computing a person's location on an image plane coordinate system. As a result, such computations erroneously include or exclude people detected in the image, which can cause confusion in the video conference and lead to a less desirable experience for the participants.

Accordingly, in some examples, the present disclosure provides methods of and apparatus for implementing inclusion zones to remove or reduce background sounds, side conversations, or other distracting noises from a videoconference. In particular, the present disclosure provides a method of calibrating inclusion zones for an image captured by a videoconference system to select data, e.g., audio or visual data, associated with a video conference subject for downstream processing in the videoconference. By utilizing the inclusion zone methods and apparatus discussed herein, the communication between participants in the teleconference may be clearer, and the overall videoconferencing experience may be more enjoyable for videoconference participants. Further, the methods and apparatus discussed herein are applicable to a wide variety of different locations and room designs, meaning that the disclosed methods may be easily assembled and applied to any particular location, including, e.g., conference rooms, enclosed rooms, and open concept workspaces.

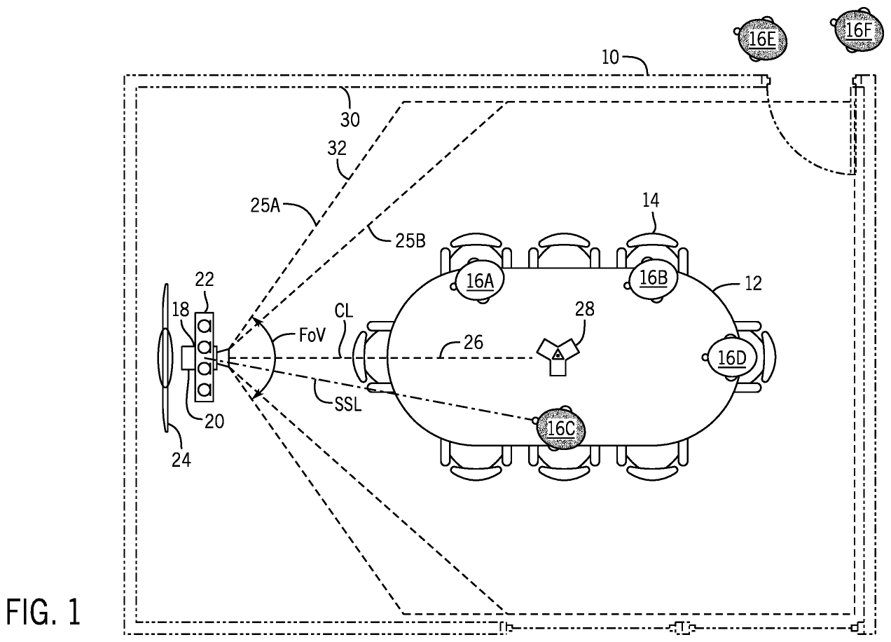

By way of example, FIG. 1 illustrates an example conference room 10 for use in videoconferencing. The conference room 10 includes a conference table 12 and a series of chairs 14. Persons 16 are seated in the chairs 14 around the conference table 12, and additional persons 16 can be located outside of the conference room 10. In the non-limiting example illustrated in FIG. 1, a first person 16A, a second person 16B, a third person 16C, and a fourth person 16D are seated around the conference table 12, while a fifth person 16E and a sixth person 16F are located outside of the conference room 10. Additionally, while FIG. 1 illustrates an example of a videoconference room 10 with six persons 16, more or fewer persons 16 may be seated around the conference table 12 or otherwise situated within the conference room 10 at any given time. Further, more or fewer persons 16 may be located outside the conference room 10 at any given time. Additional examples of videoconference rooms, locations of persons relative to videoconference rooms, and arrangements of inclusion zones in videoconference rooms will be discussed below in greater detail.

Referring still to FIG. 1, in some aspects, a videoconferencing system 18 can include a camera 20, a microphone array 22, and a monitor 24. More specifically, as shown in the example of FIG. 1, the videoconferencing system 18 can include a primary or front camera 20. However, it is contemplated that the videoconferencing system 18 may include additional cameras (e.g., a secondary or left camera, a tertiary or right camera, and/or other cameras). The camera 20 has a field-of-view (FOV) 25, horizontal and vertical, and an axis or centerline (CL) 26 extending in a direction that corresponds to the direction in which the camera 20 is pointing (i.e., the camera's 20 line of sight that is straight at 90-degrees from its focal point). For example, the camera 20 can have a horizontal FOV 25A which pans horizontally, i.e., along a width dimension, in the conference room 10, and a vertical FOV 25B which pans vertically, i.e., along a height dimension, in the conference room 10. In some aspects, the camera 20 includes a corresponding microphone array 22 that may be used to record and transmit audio data in the videoconference using sound source localization (SSL). In some examples, SSL is used in a way that is similar to the uses described in Int'l. App. No. PCT/US2023/016764 and U.S. Patent App. Pub. No. 2023/0053202, which are incorporated herein by reference in their entirety. In some examples, the microphone array 22 is housed on or within a housing of the camera 20. In addition, the videoconferencing system 18 can include a monitor 24 or television that is provided to display a far end conference site or sites and generally to provide loudspeaker output. The monitor 24 can be coupled to the front camera 20 and the microphone array 22, although it is contemplated that the monitor can be positioned anywhere in the conference room 10, and that the videoconferencing system 18 may include additional monitors (not shown) positioned in the conference room 10.

Further, the centerline 26 of the camera 20 is centered along the conference table 12. In some examples, a central microphone 28 is provided to capture a speaker, i.e., the person speaking, for transmission to a far end of the videoconference. In some aspects, a person 16 may be located within the FOV of the camera 20 and/or create a noise that is registered by the microphone array 22 even though the person 16 is located outside of the conference room 10. In the non-limiting example illustrated in FIG. 1, the fifth and sixth persons 16E, 16F are located outside of the conference room 10 but may still be within the FOV of the camera 20. For example, a left wall 30 of the conference room 10 is a transparent, e.g., glass, wall, and the fifth and sixth persons 16E, 16F can be visible through the left wall 30. In some aspects, sound and/or movement created by the persons 16E, 16F may cause confusion in the videoconference and result in distracting noises being transmitted to a far end of the videoconference. Thus, it can be advantageous to screen or filter subject data associated with each person 16 based on each person's location, i.e., position from the camera 20. This, in turn, can reduce confusion in the videoconference by ensuring that only persons who are actively participating in the videoconference are recorded and transmitted to a far end of the videoconference.

Moreover, the camera 20 and the microphone array 22 can be used in combination to define an inclusion boundary or zone 32 so that data associated with each person 16A, 16B, 16C, 16D who is within the inclusion zone 32 can be processed for transmission to a far end of the videoconference via the microphone array 22. In this way, data associated with persons 16E, 16F who are outside of the inclusion zone 32 can be filtered, e.g., not relayed to a far end of the videoconference.

To that end, an inclusion zone can act as a boundary for the videoconference system 18 to differentiate data that originates within the boundary from data that originates outside of the boundary. A variety of different videoconferencing techniques can incorporate this differentiation to enhance user experience during a videoconference. For example, incorporating an inclusion zone in a videoconferencing system can be used to select data to transmit to a far end of the videoconference and/or select data to be filtered, e.g., muted, blurred, cropped, etc. In some examples, an inclusion zone can be used to mute audio data, i.e., sounds, that originate outside of the inclusion zone to achieve the effect of a 2D acoustic fence, such as those described in Int'l Application No. PCT/US2023/016764, which is incorporated herein by reference in its entirety. Correspondingly, an inclusion zone can be used to blur video data, i.e., images, that contain persons located outside of the inclusion zone, such as persons 16E, 16F in the example of FIG. 1. In addition, data originating from within an inclusion zone that is selected to be transmitted to a far end of a videoconference can be normally processed, e.g., using optimal view selection techniques such as those described in Int'l. App. No. PCT/US2023/075906, filed Oct. 4, 2023, which is incorporated herein by reference in its entirety. Moreover, an inclusion zone can act as a motion zone, meaning that a videoconferencing system can perform a specified function after a person enters the inclusion zone. As a non-limiting example, the videoconferencing system may display a greeting message or emit a voice cue after the videoconferencing system recognizes that a person has entered an inclusion zone. Additional applications of an inclusion zone in a videoconference will be discussed below in greater detail.

Accordingly, using an inclusion zone in a videoconferencing setting can prevent and/or eliminate distractions that originate from outside of a conference room, thereby providing a more desirable video conferencing experience to far end participants. The processes described herein allow for a videoconference system to define inclusion zones in a conference room to selectively filter data associated with each person detected by a camera based on each person's location relative to the camera. This is accomplished using an artificial intelligence (AI) or machine learning human head detector model, as discussed below.

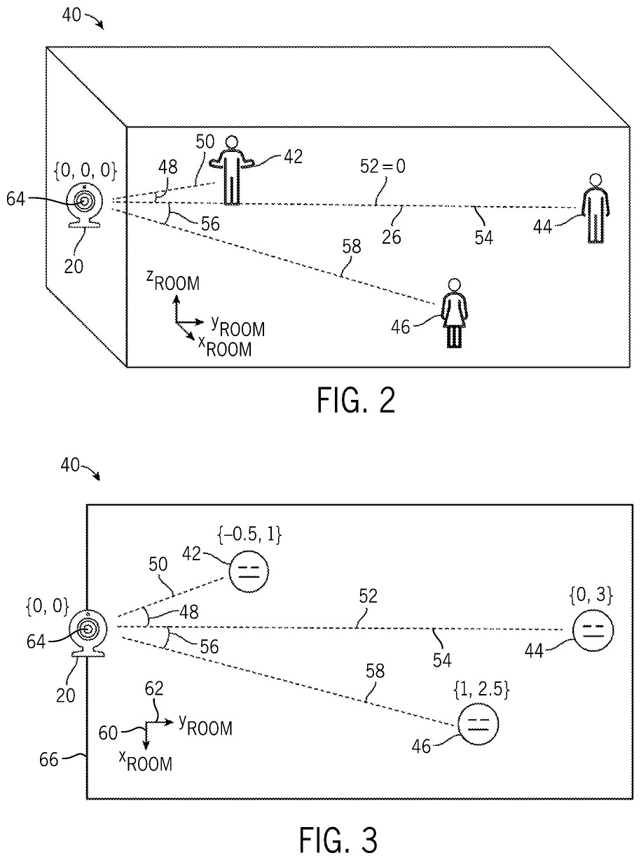

In some aspects, the AI human head detector model, which may also be referred to herein as a subject detector model, is substantially similar to that described in Int'l. App. No. PCT/US2023/016764, which is incorporated herein by reference in its entirety. For example, referring now to FIGS. 2 and 3, a conference room 40 is illustrated with three videoconference participants 42, 44, 46 located at different coordinate positions. In the conference room 40, the front camera 20 has horizontal and vertical FOV, and the camera location with respect to the room 40 is denoted by the three-dimensional (3D) coordinates {0, 0, 0}. Further, the front camera 20 captures a view of all three participants 42, 44, 46 having locations that can be characterized in terms of a pan angle ΦPAN relative to a centerline 26 of the front camera 20 and a distance measure between the front camera 20 and each participant 42, 44, 46. In particular, a first participant 42 has a location defined by a first pan angle 48 and a first distance 50. In addition, a second participant 44 has a location defined by pan angle 52 and a second distance 54, and a third participant 44 has a location defined by pan angle 56 and a third distance measure 58.

Referring now specifically to FIG. 3, a top view is illustrated of the example conference room 40 of FIG. 2. In some examples, the location of each participant 42, 44, 46 may be characterized in terms of the pan angles 48, 52, 56 and distances 50, 54, 58 that are derived from an x_{ROOM} dimension or axis 60 and a y_{ROOM} dimension or axis 62, where the front camera 20 is located at {x_{ROOM}, y_{ROOM}} coordinate positions of {0, 0}. In particular, the first participant 42 has a location defined by the first pan angle 48 and a first distance measure 50 which is characterized by two-dimensional room distance parameters {−0.5, 1} to indicate that the participant is located at a “vertical” distance (in relation to the top view) of 1 meter, measured from the front camera 20 along the y_{ROOM} axis 62, and at a “horizontal” distance of −0.5 meters, measured along the x_{ROOM} axis 60 that is perpendicular to the y_{ROOM} axis 62. In addition, the second participant 44 has a location defined by the second pan angle 52 and a second distance measure 54 which is characterized by two-dimensional room distance parameters {0, 3} to indicate that the participant is located at a vertical distance of 3 meters (measured along the y_{ROOM} axis 62) and at a horizontal distance of 0 meters (measured along the x_{ROOM} axis 60) to indicate that the second person is located along the centerline 26 of the front camera 20. Finally, the third participant 44 has a location defined by a third pan angle 56 and a third distance measure 58 which is characterized by two-dimensional room distance parameters {1, 2.5} to indicate that the participant is located at a vertical distance of 2.5 meters (measured along the y_{ROOM} axis 62) and at a horizontal distance of 1 meter (measured along the x_{ROOM} axis 60).

The relationship between the pan angle values (ΦPAN) and the two-dimensional room distance parameters {x_{ROOM}, y_{ROOM}} may be determined by using a reference coordinate table (not shown) in which pan angle ΦPAN values for the videoconference front camera 20 are computed for meeting participants located at different coordinate positions {x_{ROOM}, y_{ROOM}} in the example conference room 40 of FIGS. 2 and 3. An identical table (not shown) of negative pan angle ΦPAN values (e.g., −ΦPAN) can be computed for coordinate positions of {−x_{ROOM}, y_{ROOM}} in the example conference room 40. Thus, it will be understood that the same pan angle ΦPAN value (e.g., ΦPAN=0) will be generated for a meeting participant located along the centerline 26 of the front camera 20 (e.g., x_{ROOM}=0) at any depth measure (e.g., y_{ROOM}=0.5-8). Similarly, the same pan angle ΦPAN value (e.g., ΦPAN=45) will be generated for a meeting participant located at any coordinate position where x_{ROOM}=y_{ROOM}. As illustrated, the pan angle ΦPAN alone may not be sufficient information for determining the two-dimensional room distance parameters {x_{ROOM}, y_{ROOM}} for the location of a participant. For example, the first participant 42 may appear larger to the front camera 20 than the second participant 44 due to vanishing points perspective. Thus, as a meeting participant moves further away from the front camera 20, the apparent height and width of the participant become smaller to the videoconferencing system, and when projected to a camera image sensor 64, meeting participants are represented with a smaller number of pixels compared to participants that are nearer to the front camera 20. Further, if two heads are seen by the front camera 20 as having the same size, they are not necessarily located at the same distance, and their locations in a two-dimensional x_{ROOM}-y_{ROOM} plane 66, as illustrated in FIG. 3, may be different due to the pan angle ΦPAN and distortion in the height and width.

In particular, the statistical distribution of human head height and width measurements may be used to determine a min-median-max measure for the participant head size in centimeters. Additionally, by knowing the FOV resolution of the front camera 20 in both horizontal and vertical directions with the respective horizonal and vertical pixel counts, the measured angular extent of each head can be used to compute the percentage of the overall frame occupied by the head and the number of pixels for the head height and width measures. Using this information to compute a look-up table for min-median-max head sizes (height and width) at various distances, an artificial (AI) human head detector model can be applied to detect the location of each head in a two-dimensional viewing plane with specified image plane coordinates and associated width and height measures for a head frame or bounding box (e.g., {x_{box}, y_{box}, width, height}). By using the reverse look-up table operation, the distance can be determined between the front camera 20 and each head that is located on the centerline 26 of the front camera 20.

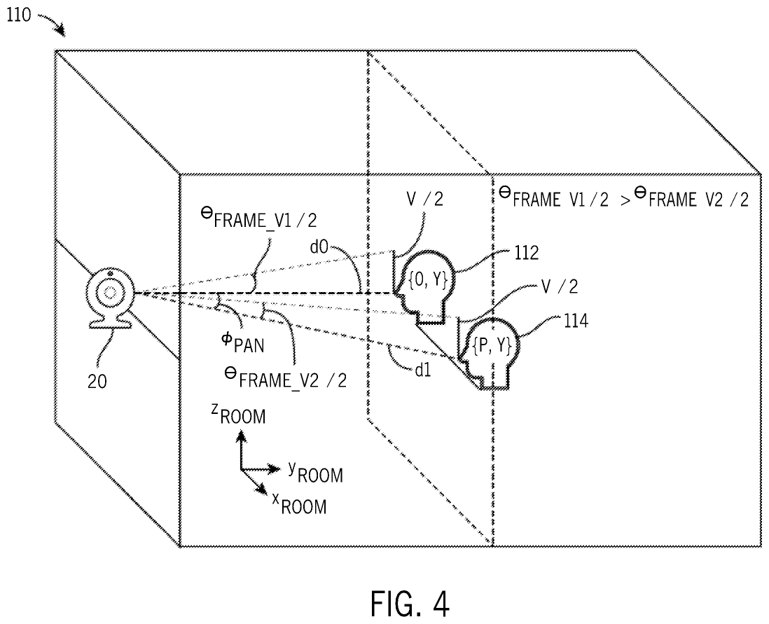

In some examples, the subject detection process is similar to the AI head detection process as disclosed in U.S. patent application Ser. No. 17/971,564, filed on Oct. 22, 2022, which is incorporated by reference herein in its entirety. Referring specifically to FIG. 4, a front camera 20 is used to provide an image of a meeting participant taken along a two-dimensional image plane 110. The meeting participant can be located in a first, centered position 112 and a second, panned position 114 that is shifted laterally in the x_{ROOM} direction. In the first, centered position, the meeting participant is located along the centerline 26 of the camera 20 (e.g., ΦPAN=0) at a distance, d0=Y meters, so the two-dimensional room distance parameters for the first, centered position 112 are {x_{ROOM}=0, y_{ROOM}=Y}. In the second, panned position, the meeting participant is shifted laterally in the x_{ROOM} direction by a panned angle ΦPAN and is located at d1>d0 meters, so the two-dimensional room distance parameters for the second, panned position 114 are {x_{ROOM}=P, y_{ROOM}=Y}. Further, the same vertical head height measure V/2 for the meeting participant positions 112, 114 will result in an angular extent θFRAME_V1/2 for the first meeting participant position 112 that is larger than the angular extent θFRAME_V2/2 for the second meeting participant position 114. In effect, the fact that the second, panned position 114 is located further away from the front camera 20 than the first, centered position 112 (d1>d0) results in the angular extent for the second, panned position 114 appearing to be smaller than the angular extent for the first, centered position 112 so that θFRAME_V1/2>θFRAME_V2/2.

From the foregoing, the issue is to find an angular extent for the entire head height θ_{HH} and then represent it as a percentage of the full frame vertical field of view (VFrame_Percentage) which is then translated into the number of pixels the head will occupy (VHead_Pixel_Count) at a particular distance and at a pan angle ΦPAN. To this end, the angular extent for the entire head height θ_{HH1} for the first meeting participant location 112 may be calculated by starting with the equation, tan (θ_{HH1}/2)=(V/2)/d0. Solving for the angular extent θ1, the angular extent for the entire head height θ_{HH1} may be calculated as θ_{HH1}=2 arctan ((V/2)/d0). In similar fashion, the angular extent for the entire head height θ_{HH2} for the second meeting participant position 114 located at the pan angle ΦPAN may be calculated by starting with the equation, tan (θ_{HH2}/2)=(V/2)/d1, where d1=\sqrt{d0²+P²}. Solving for the angular extent θ_{HH2}, the angular extent for the entire head height θ_{HH2} may be calculated as θ_{HH2}=2×arctan ((V/2)/d1)=2×arctan ((V/2\sqrt{d0²+P²})). Based on this computation, the percentage of the frame occupied by the head height for the second meeting participant location 114 can be computed as VFrame_Percentage=θ_{HH2}/Vertical FOV. In addition, the corresponding number of pixels for the head height for the second meeting participant location 114 can be computed as VHead_Pixel_Count=VFrame_Percentage×Vertical FOV in pixels. Based on the foregoing calculations, the angular extent for the entire head height θ_{HH}=θFRAME_V may be calculated at discrete distances of, for example, 0.5 meters in each of the x_{ROOM} and y_{ROOM} directions that are equivalent to various angular pan angles ΦPAN which may be listed in a look-up table (not shown).

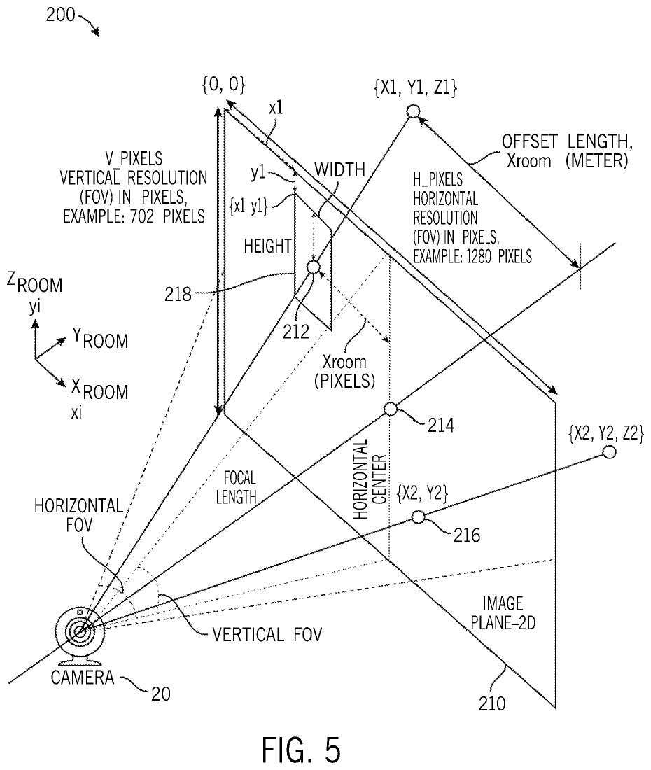

FIG. 5 illustrates a front camera 20 and a videoconference room 200 including a two-dimensional image plane 210 to illustrate how to calculate a vertical or depth room distance Y_{ROOM} (meters) to the meeting participant location from the distance measure X_{ROOM} (meters) by calculating a direct distance measure HYP between the front camera 20 and the meeting participant location. The two-dimensional image plane 210 includes a plurality of two-dimensional coordinate points 212, 214, 216 that are defined with image plane 210 coordinates {xᵢ,yᵢ} as described above. In addition, a head bounding box 218 is defined with reference to the starting coordinate point {x₁, y₁} for the head bounding box 218, a Width dimension (measured along the xᵢ axis), and a Height dimension (measured along the yᵢ axis). To locate the vertical or depth room distance Y_{ROOM} (meters) from the front camera 20, a vertical angular extent (Θ) for the head bounding box 218 is computed as Θ=Height*V_FOV/V_PIXELS, where Height is the height of the head bounding box in pixels, where V_FOV is the Vertical FOV in degrees, and where V_PIXELS is the Vertical FOV in Pixels. Next, a vertical angular extent for the upper half of the head bounding box is computed (Θ/2) and used to derive the direct distance measure HYP between the front camera 20 and the meeting participant location, HYP=V_HEAD/(2×tan (η/2)), where HYP is the direct distance measure to the meeting participant location at the pan angle ΦPAN. Finally, the vertical or depth room distance Y_{ROOM} (meters) is derived from the direct distance measure HYP and the distance measure x_{ROOM} (meters) using Pythagorean's Theorem, Y_{ROOM}=\sqrt{HYP²−X_{ROOM}²}.

With this understanding of the AI human head detector model, the present disclosure provides methods, devices, systems, and computer readable media to accurately determine if a source of subject data, e.g., audio or visual data, originates within an inclusion zone defined by a videoconferencing system. The location of each person with a FOV of a camera is determined by the AI human head detector model using room distance parameters, as discussed above. In particular, coordinates, e.g., image and/or world coordinates, are determined for each person in the camera view. In some aspects, the world coordinates identified by the AI human detector model are referred to as world coordinate points. The world coordinates of human heads are then compared to room parameters that correspond to the inclusion zone(s) defined by the videoconferencing system. In this way, it becomes possible to determine if data, e.g., an image of a particular head captured by a camera or a sound recorded by a microphone array, has originated from within an area delimited by the inclusion zone or from outside of the area delimited by the inclusion zone. If the data is determined to have originated from within the inclusion zone, the videoconferencing system processes the data and transmits the data to a far end of the videoconference. However, if the data is determined to have originated from outside of the inclusion zone, the videoconferencing system processes the data in a different manner, for example, filters the data and may not transmit the data to far end participants in the videoconference. Any suitable filtering technique may be used to prevent or adjust data that originates from outside of an inclusion zone from being transmitted downstream in a videoconference, such as, e.g., audio muting, video blurring, video cropping, etc. In some examples, filtering subject data can also include preventing people who are located outside of an inclusion zone from being framed or tracked, e.g., using group framing, people framing, active speaker framing, and tracking techniques. Moreover, it is contemplated that multiple inclusion zones, boundary lines, and/or exclusion zones may be defined using the methods discussed herein.

Generally, in some aspects, a calibration method may be used to determine videoconferencing room dimensions and/or to define an inclusion zone in a videoconferencing room. For example, the calibration method may be used to determine dimensions of the videoconferencing room, and the entire videoconferencing room may be considered an inclusion zone or a portion of the videoconferencing room may be defined as the inclusion zone. As another example, the calibration method may be used to determine the inclusion zone without first determining videoconferencing room dimensions. These calibration methods may be automatic or manual, and may be completed initially upon setup of the videoconferencing room and/or periodically while using the videoconferencing system.

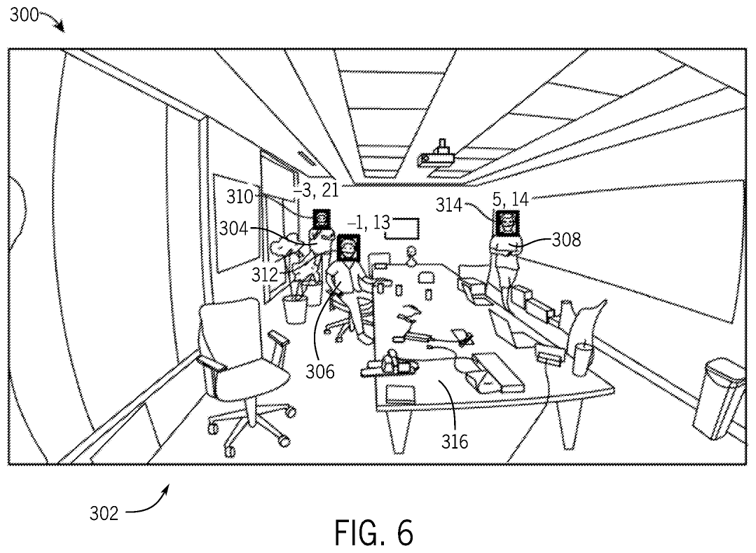

According to one example, videoconference room dimensions can be defined during an automatic calibration phase in which a videoconferencing system can use locations of meeting participants to automatically determine maximum world coordinates of the videoconferencing room and, further optionally, an inclusion zone. For example, FIG. 6 illustrates a picture image 300 of another example conference room 302. Three subjects or participants 304, 306, 308 are located in the room 302 at different coordinate positions and with corresponding head frames or bounding boxes 310, 312, 314 identified in terms of the coordinate positions for each of the participants 304, 306, 308. The bounding boxes 310, 312, 314 can be overlaid on the image 300 using the subject detector model as discussed above. Further, the coordinate positions may be measured with reference to a room width dimension x_{ROOM} and a room depth dimension y_{ROOM}. The room width dimension x_{ROOM} extends across a width of the room 302 from the centerline 26 (see FIG. 1) of the front camera 20 (see FIG. 1) so that negative values of x_{ROOM} are located to the left of the centerline 26 (see FIG. 1) and positive values of x_{ROOM} are located to the right of the centerline 26 (see FIG. 1). In addition, the room depth dimension y_{ROOM} extends down a length of the room 302 parallel with the centerline 26 of the front camera 20 (see FIG. 2).

By applying computer vision processing to the image 300, a first meeting participant 304 is detected in the back left corner of the room 302, and an interest region around the head of the first meeting participant 304 is framed with a first head bounding box 310, where the first meeting participant 304 is located at the two-dimensional room distance parameters (x_{ROOM}=−3, y_{ROOM}=21). In similar fashion, a second meeting participant 306 seated at a table 316 is detected with the head of the second meeting participant 306 framed with a second head bounding box 312, where the second meeting participant 306 is located at the two-dimensional room distance parameters (x_{ROOM}=−1, y_{ROOM}=13). Finally, a third meeting participant 308 standing to the right is detected with the head of the third meeting participant 308 framed with a third head bounding box 314, where the third meeting participant 308 is located at the two-dimensional room distance parameters (x_{ROOM}=5, y_{ROOM}=14).

During an automatic calibration phase, the videoconference room 302 can be automatically determined using the maximum and minimum room parameters {x_{ROOM}, y_{ROOM}} of the detected participants 304, 306, 308. In particular, the automatic calibration phase can measure maximum and minimum room width parameters x_{ROOM} as well as a maximum room depth parameters y_{ROOM} using the coordinates of the participants 304, 306, 308. In the non-limited example illustrated in FIG. 6, the participants 304, 306, 308 are located at room dimensions {x_{ROOM}, y_{ROOM}} of (−3, 21), (−1, 13), and (5, 14), respectively. Thus, following automatic calibration, the videoconference system can determine that the videoconferencing room 302 has minimum and maximum room width dimensions x_{ROOM} of (−3, 5), respectively. Further, the videoconferencing room 302 can have a room depth dimension y_{ROOM} of (0, 21). Put another way, videoconferencing room 302 can have room dimensions of at least 8 units wide and 21 units deep. From these videoconferencing room 302 dimensions, an inclusion zone can be defined as the entire room or a portion of the room.

Accordingly, it will be understood that videoconferencing room 302 dimensions can be defined in a conference room based on participant location measured during a calibration phase. In some aspects, the automatic calibration phase is activated by a moderator or participant of the videoconference, e.g., using a controller or pushing a calibration phase button on a camera, or the automatic calibration phase can be activated automatically when a first participant enters a FOV of the camera, as will be discussed below in greater detail. In addition, the automatic calibration phase can be activated for a pre-determined amount of time, e.g., 30 seconds, 60 seconds, 120 seconds, 300 seconds, etc., or the automatic calibration phase can be continuously active. For example, the automatic calibration phase can track participant location in a conference room for a longer period of time, e.g., hours or days, to generate a predictable model of participant location in the conference room, meaning that an inclusion zone can be automatically updated or changed over time.

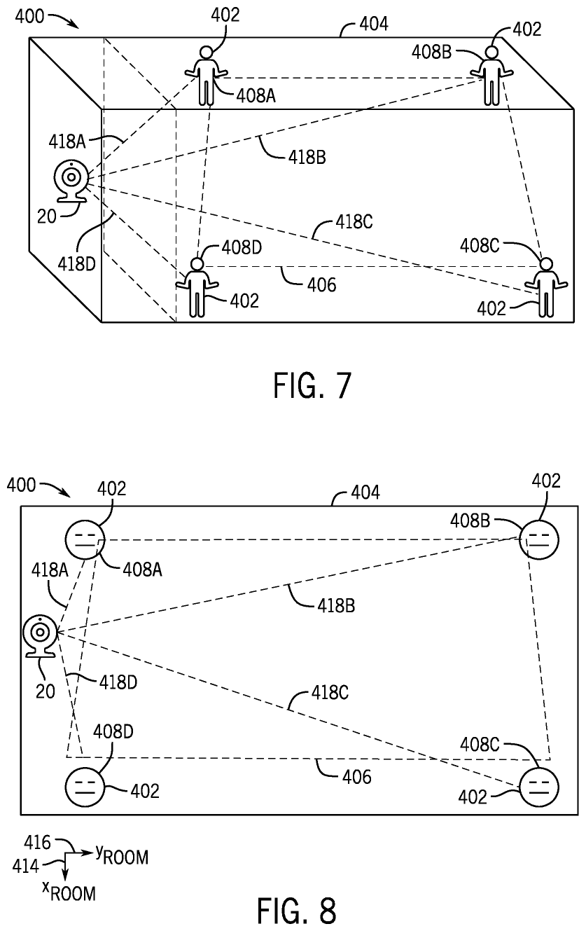

In other examples, videoconferencing room dimensions can be defined during a manual calibration phase in which a human installer, e.g., a moderator or a videoconference participant, manually sets the shape and size of the videoconferencing room and, optionally, an inclusion zone. FIGS. 7 and 8 illustrate another example conference room 400 with a single installer 402 walking around a perimeter 404 of the room 400 as a front camera 20 is in a manual calibration phase to define dimensions of the room 400 and, optionally, an inclusion zone 406 in the room 400. In particular, the installer 402 can activate the manual calibration mode and proceed to walk between different positions 408 in the room. The camera 20 can track the installer 402 as the installer 402 moves in the room 400 to define boundaries or dimensions of the room 400 and/or an inclusion zone 406. It will be apparent that the installer 402 can move around the room 400 to define any particular shape, meaning that the inclusion zone 406 can also be defined in any particular shape or shapes, e.g., a triangle, a rectangle, a quadrilateral, a circle, etc. For example, the installer 402 can walk between a first position 408A, a second position 408B, a third position 408C, and a fourth position 408D, which may correspond to corners of the room 400. Using the subject detector model as discussed above, the camera 20 can determine and record world coordinates for each position 408 that the installer 402 walks through, or the camera 20 can continuously determine and record world coordinates of the installer 402 during the manual calibration phase. Put another way, the installer 402 can draw the room 400 and/or the inclusion zone 406 by walking around the room 400 when the camera 20 is in the manual calibration mode.

Referring specifically to FIG. 8, a top-down view is illustrated of the conference room 400 of FIG. 7. In some aspects, the camera 20 can use the AI head detector model to determine a distance between the camera 20 and the installer 402 to accurately define dimensions of the room 400 and/or the inclusion zone 406 in terms of horizontal pan angles and depth distances that are derived from an x_{ROOM} dimension or axis 414 and a y_{ROOM} dimension or axis 416, where the camera 20 is located at {x_{ROOM}, y_{ROOM}} coordinate positions of (0, 0). For example, the camera 20 can determine that the participant is at a first distance 418A in the first position 408A, a second distance 418B in the second position 408B, a third distance 418C in the third position 408C, and a fourth distance 418D in the fourth position 408D. Accordingly, the camera 20 can define the inclusion zone 406 based on the distances 418 measured as the installer 402 moves through the room 400 during the manual calibration phase. In some aspects, the installer 402 may choose not to walk around the perimeter 404 of the room 400, e.g., walking around a smaller portion of the room 400 or in a shape that is different than the shape of the room 400. Further, the installer 402 can activate the manual calibration mode before a videoconference takes place, or the installer 402 can activate the manual calibration mode and define the inclusion zone 406 at the beginning of a videoconference, i.e., after all participants have entered the room 400.

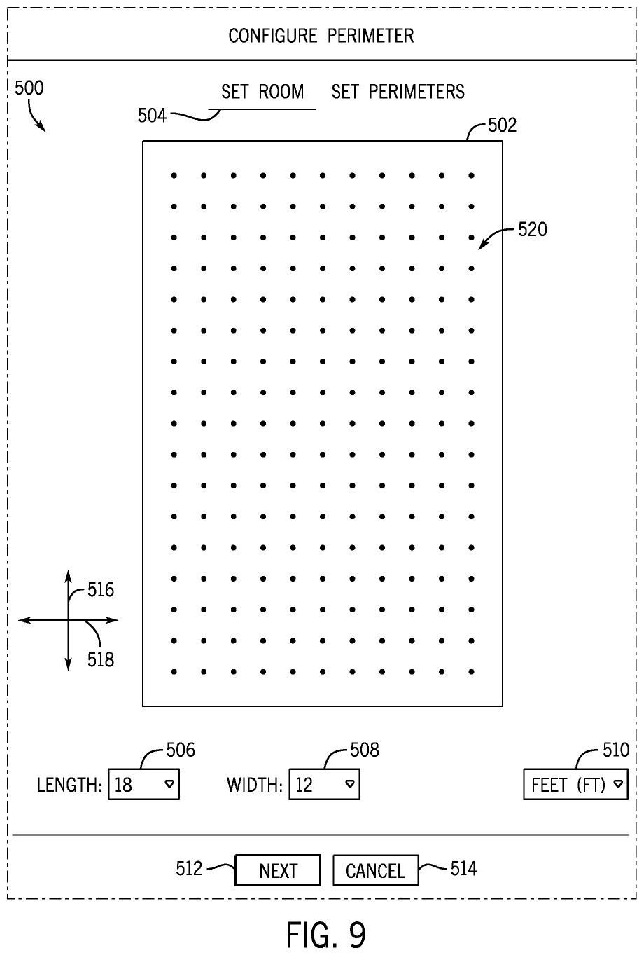

In other examples, an installer or user can manually input coordinates of a room and an inclusion zone during the manual calibration phase using, for example, a graphical user interface (GUI) on a computer monitor screen or a tablet screen. Referring now to FIG. 9, a room configuration GUI 500 is illustrated which includes a top view of a room 502 and a “set room” page 504 that can be selected by the user to at least define dimensions of the room 502 and/or adjust placement of a camera pin (not shown). While the GUI 500 is illustrated as including a rectangular room 502, the room 502 can be arranged in any suitable shape, e.g., an ovular room, a circular room, a triangular room, etc. Further, a variety of different inputs may be used to allow a user to control certain aspects in the GUI 500, including any acceptable human interface devices, e.g., touch enabled devices, button inputs, keyboards, mice, track balls, joysticks, touch pads, or the like.

Still referring to FIG. 9, the GUI 500 can include a first field box 506, a second field box 508, a third field box 510, a “next” icon 512, and a “cancel” icon 514. However, it is contemplated that the “set room” page 504 of the GUI 500 can include more or fewer field boxes than those illustrated in FIG. 9. In some aspects, each of the field boxes 506, 508, 510 can be text field boxes in which a user manually enters numbers or text, e.g. using a keyboard, or each of the field boxes 506, 508, 510 can be configured as drop down lists (DDLs). The field boxes 506, 508, 510 can be used to define dimensions of the room 502 in terms of, e.g., length, width, depth, radius, curvature, etc. in particular units of measure, e.g., feet, meters, etc.

As illustrated in the non-limiting example of FIG. 9, the first field box 506 can correspond to depth of the room 502 measured along a y_{ROOM} dimension or axis 516, and the second field box 508 can correspond to a width of the room 502 measured along an x_{ROOM} axis 518. For example, the first and second field boxes 506, 508 can be DDLs of numbers, e.g., 1, 2, 3, etc., and the third field box 508 can be a DDL of different units of measurement, e.g., feet (ft) and meters (m). Accordingly, a user can define length and width dimensions of the room 502 by populating the field boxes 506, 508, 510. For example, a user can populate the first field box 506 with “18”, the second field box 508 with “12”, and the third field box 510 with “feet (ft)” to define a room that is 18 feet long and 12 feet wide relative to the y_{ROOM} and x_{ROOM} axes 516, 518, respectively.

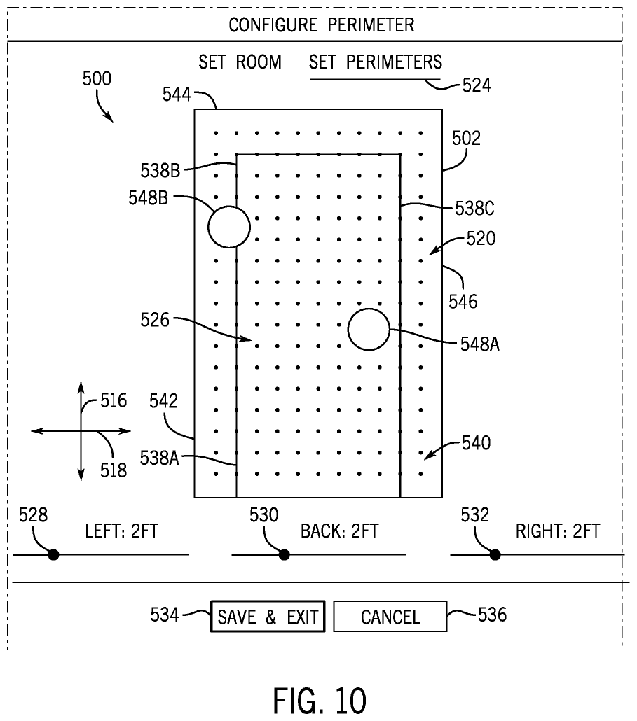

In addition, a grid 520 can be overlaid on the top view of the room 502 in the GUI 500, where the grid 520 can change shape dependent on the dimensions of the room, and the grid 520 can be sized according to the units selected in the third field box 510. In some aspects, a user can draw the room 502 instead of manually inputting dimensions in the field boxes 506, 508, 510, which can be advantageous, for example, if the room 502 is an irregular shape. Additionally, a user can place a “pin” (not shown) anywhere along the grid 520 corresponding to a location of a camera within the room 502. After dimensions have been set for the room 502, i.e., using the field boxes 506, 508, 510, a user can select the “next” icon 512 to move to a “set perimeter” page 524 (see FIG. 10), or a user can select the “cancel” icon 514 to reset the room dimensions and/or return to a home page (not shown) of the GUI 500.

Referring now to FIG. 10, the “set perimeter” page 524 of the GUI 500 is illustrated, the “set perimeter” page 524 including the top view of the room 502, an inclusion zone 526 overlaid on the room 502, a first slider 528, a second slider 530, a third slider 532, a “save & exit” icon 534, and a “cancel” icon 536. Specifically, an area of the room 502 enclosed by a perimeter or virtual boundary line 538 can define the inclusion zone 526. Correspondingly, an area of the room 502 that is outside of the boundary line 538 can be defined as an exclusion zone 540. In this way, the boundary line 538 can be used to determine what data or types of data to transmit to a far end of a videoconference, as will be discussed below in greater detail.

To define the boundary line 538 on the room 502, a user may manually draw the boundary line 538 within the grid 520, or the user can use the sliders 528, 530, 532 to adjust the boundary line 538 relative to the dimensions of the room 502. However, it is contemplated that the “set perimeter” page 534 can include more or fewer sliders than those illustrated in FIG. 10. Further, the “set perimeter” page 524 may include field boxes with DDLs instead of sliders, or the “set perimeter” page 524 can include both field boxes and sliders.

In some aspects, the sliders 528, 530, 532 can be used to adjust inclusion zone boundary lines which correspond to sides of the room 502, e.g., a left or first side 542, a back or second side 544, and a right or third side 546. For example, the first slider 528 can be used to move a first boundary line 538A inward from or outward to the first side 542 of the room 502, the second slider 530 can be used to move a second boundary line 538B inward from or outward to the second side 544 of the room 502, and the third slider 528 can be used to move a third boundary line 538C inward from or outward to the third side 546 of the room 502. Accordingly, the size of the inclusion zone 526 can be incrementally adjusted as desired. In the non-limiting example illustrated in FIG. 10, the boundary lines 538A, 538B, 538C are each spaced from the sides 542, 544, 546 of the room 502, respectively, by two feet, as indicated by the sliders 528, 530, 532.

Once the boundary line 538 is adjusted as desired and the inclusion zone 526 is defined in the room 502, a user can select the “save & exit” icon 534 to save the configuration of the inclusion zone 526, meaning that the inclusion zone 526 is active in the room 502. Alternatively, the user can select the “cancel” icon 536 to reset the boundary line 538 dimensions and/or return to a home page (not shown) of the GUI 500. In some examples, a user may desire to adjust the inclusion zone 526 after a videoconference has started due to, e.g., a person entering or exiting the conference room, a change in environmental conditions, or another reason. Accordingly, the user can re-enter the manual calibration mode at any point during the videoconference and readjust the inclusion zone using, e.g., the sliders 528, 530, 532. Further, it is contemplated that the manual calibration mode and the automatic calibration mode as discussed above in relation to FIGS. 6-8 may be used together during a videoconference. For example, a user may initially define an inclusion zone 526 using the manual calibration mode before switching to the automatic calibration mode after a videoconference has started. Alternatively, a user may use the automatic calibration mode to define the inclusion zone 526 before switching to the manual calibration mode to adjust the boundaries of the inclusion zone 526.

With continued reference to FIG. 10, all data captured by the camera 20 (see FIG. 1) and a microphone, e.g., the microphone array 22 (see FIG. 1), that originates outside of the inclusion zone 526, i.e., within the exclusion zone 540, can be filtered, e.g., muted or blurred, while all data captured by the camera 20 and the microphone (see FIG. 1) that originates within the inclusion zone 526 can be provided to a far end of the videoconference. In this way, data originating from outside the inclusion zone 526 can be differentiated from data originating from inside the inclusion zone 526.

In addition, the GUI 500 can be used to track people in the room 502 in real time to determine if they are within the inclusion zone 526 or not. Specifically, room or world coordinates of people in the room 502 can be determined using an AI head detector model, and the world coordinates can then be compared to the world coordinates of the inclusion zone 526 to determine if a person is within the inclusion zone 526 or not. For example, a first person 548A and a second person 548B can be located in the room 502, and an AI head detector model can be applied to an image of the room 502 captured by the camera 20 (see FIG. 1) to determine coordinates for each person 548. As illustrated, the first person 548A is positioned within the boundary line 538, i.e., within the inclusion zone 526, so any data recorded by the camera 20 and/or the microphone (see FIG. 1) which originates from the first person 548A may be processed by the videoconferencing system and transmitted to a far end of a videoconference. Relatedly, the second person 548B is positioned at least partially outside of the inclusion zone 526, i.e., partially within the exclusion zone 540. Thus, a person 548 can be considered to be outside of the inclusion zone 526 if the person 548 is positioned at least partially on the boundary line 538 and/or at least partially within the exclusion zone 540. Alternatively, a person 548 can be considered to be outside of the inclusion zone 526 only if the person 548 is positioned outside of the boundary line 538 and entirely within the exclusion zone 540.

Referring still to the example of FIG. 10, as a result of determining that the second person 548B is outside of the inclusion zone 526, data originating from the second person 548B may still be recorded by the camera 20 and/or the microphone (see FIG. 1), but this data may also be filtered before being transmitted to a far end of the videoconference. For example, data originating from the second person 548B may be blurred, muted, lowered in volume, and/or otherwise filtered using another suitable audio or visual filtering technique. In some examples, data originating from the second person 548B may not be transmitted to a far end of the videoconference.

Thus, more generally, data originating from persons inside the inclusion zone 526 is processes differently than data originating from persons outside the inclusion zone 526. Additionally, in some applications, different filtering techniques can be used with different inclusion zones 526. That is, if multiple inclusion zones 526 are defined within a videoconference room, a user may be able to designate certain types of filtering or actions taken when participants are detected in a specific inclusion zone 526. By way of example, a “greeting zone” type of inclusion zone 526 can be defined wherein, upon detecting that a participant has entered the greeting zone, the videoconference system may start video or ask the participant if they want video to start playing on the monitor 24 (see FIG. 1). In another example, a “privacy zone” type of inclusion zone 526 can be defined wherein the videoconference system transmits data to a far end of the videoconference so that video is only focused within the privacy zone.

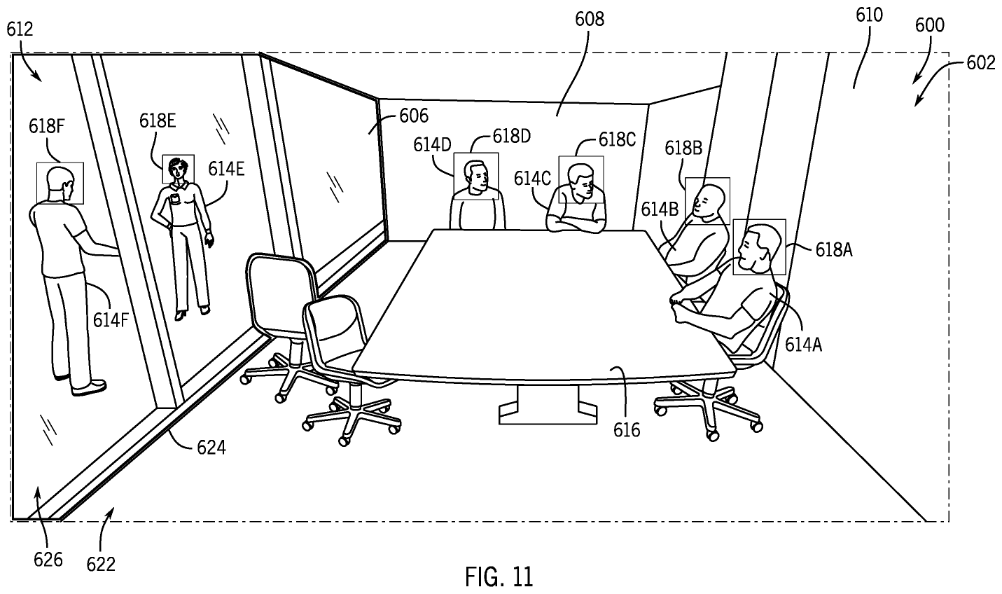

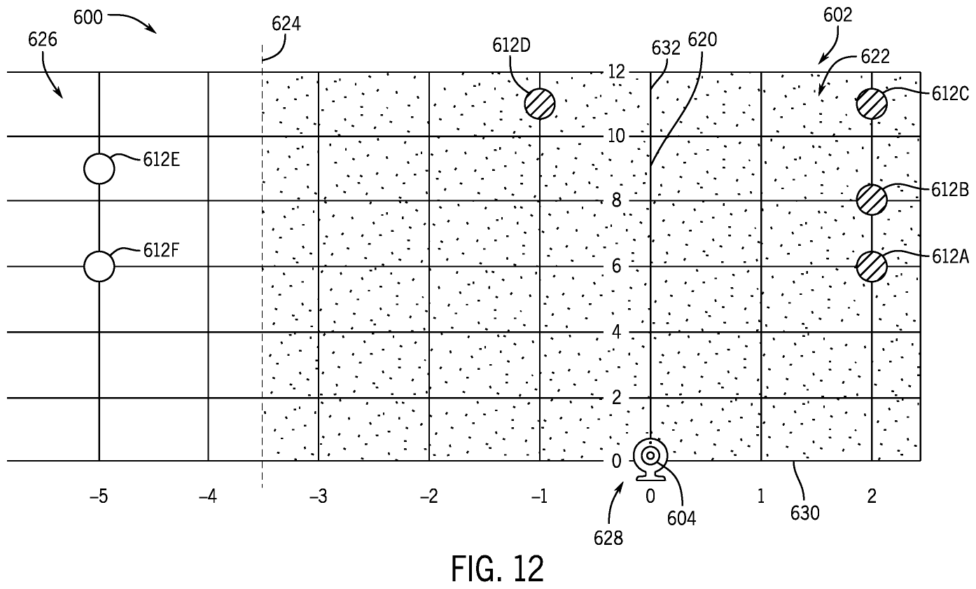

It will be apparent that the methods of using an inclusion boundary to filter subject data based on location within a conference room can be used in a variety of different conference rooms and with any number of persons. Referring now to FIG. 11, a picture image 600 is illustrated of yet another example conference room 602, with a schematic top-down view of the conference room 602 illustrated in FIG. 12. The conference room 602 includes a camera 604 (see FIG. 12) with a microphone array located at a front of the room 602, a left wall 606, a right wall 608, and a back wall 610. In some aspects, the left wall 606 may be a transparent wall, e.g., a glass wall, such that a hallway 612 adjacent to the conference room 602 is visible. In addition, a first person 614A, a second person 614B, a third person 614C, and a fourth person 614D are seated around a conference table 616 in the conference room 602, while a fifth person 614E and a sixth person 614F are located outside of the conference room 602, i.e., in the hallway 612 adjacent to the transparent left wall 606 of the conference room 602. Each of the persons 614 are located at different coordinate positions in the picture image 600 and are identified as people by applying an AI head detector model to the picture image 600. As discussed above, the AI head detector model can generate head frames or bounding boxes 618, e.g., a first bounding box 618A, a second bounding box 618B, a third bounding box 618C, etc., around each person 614, and the bounding boxes 618 can be used to determine world coordinate positions for the persons 614. Further, the world coordinate positions may be measured with reference to a room width dimension x_{ROOM} and a room depth dimension y_{ROOM}. The room width dimension x_{ROOM} can extends across a width of the room 602 from a centerline 620 of the camera 604 (see FIG. 12) so that negative values of x_{ROOM} are located to the left of the centerline 620 (see FIG. 12) and positive values of x_{ROOM} are located to the right of the centerline 620 (see FIG. 12). In addition, the room depth dimension y_{ROOM} extends down a length of the room 602 parallel with the centerline 620 of the front camera 20 (see FIG. 12).

Moreover, the persons 614 inside the conference room 602, i.e., the first person 614A, the second person 614B, the third person 614C, and the fourth person 614D, can be participants in a videoconference, and the persons 614 outside of the conference room 602, i.e., the fifth person 614E and the sixth person 614F, may not be participants in the videoconference. Nonetheless, the fifth and sixth persons 614E, 614F are captured by the camera 604 (see FIG. 12), meaning that subject data, i.e., audio and/or visual data associated with a subject or person, may be recorded and transmitted to a far end of the videoconference. Accordingly, the sound and/or movement created by the fifth and sixth persons 614E, 614F may cause confusion and/or distract far end participants in the videoconference.

To prevent distracting noises or movements from being transmitted to a far end of the videoconference, an inclusion zone 622 can be defined in the image 600 using the calibration techniques discussed above. Specifically, with reference to FIG. 12, a boundary line 624, or lines, can be overlaid on the image using room distance parameters {x_{ROOM}, y_{ROOM}} to separate the inclusion zone 622 from an exclusion zone 626. In this way, subject data originating from the persons 614A, 614B, 614C, 614D within the inclusion zone 622 can be processed and transmitted to a far end of the videoconference, while subject data originating from the persons 614E, 614F within the exclusion zone 626 can be filtered, e.g., not transmitted to a far end of the videoconference. In the non-limiting example of FIGS. 11 and 12, the boundary line 624 can be drawn along the left wall 606 such that the inclusion zone 622 can be defined between the left wall 606 and the right wall 610. Correspondingly, the exclusion zone 626 can be defined by the left wall 606, meaning that any object or person visible through the left wall 606 is within the exclusion zone 626.

Referring now to FIG. 12, the top view of the image 600 is represented using a world coordinate system 628. The world coordinate system 628 includes an x_{ROOM} axis 630 corresponding to a width of the conference room 602, and a y_{ROOM} axis 632 corresponding to a depth of the conference room 602. Correspondingly, the camera 604 is located at {x_{ROOM}, y_{ROOM}} coordinate positions of (0, 0). As discussed above, the boundary line 624 is defined along the left wall 606 such that the inclusion zone 622 can be defined to the right of the boundary line 624 and the exclusion zone 626 can be defined to the left of the boundary line 624. After the zones 622, 626 and the boundary line 624 have been defined and the room coordinates of the persons 614 have been determined, the room coordinates associated with each person 614 can be compared with the boundary line 624, as discussed above.

Still referring to FIG. 12, the first person 614A can be located at the two-dimensional room distance parameters (x_{ROOM}=2, y_{ROOM}=6), the second person 614B can be located at the two-dimensional room distance parameters (x_{ROOM}=2, y_{ROOM}=8), the third person 614C can be located at the two-dimensional room distance parameters (x_{ROOM}=2, y_{ROOM}=11), and the fourth person 614D can be located at the two-dimensional room distance parameters (x_{ROOM}=−1, y_{ROOM}=11). Additionally, the fifth person 614D can be located at the two-dimensional room distance parameters (x_{ROOM}=−5, y_{ROOM}=6), and the sixth person 614F can be located at the two-dimensional room distance parameters (x_{ROOM}=−5, y_{ROOM}=9). Moreover, the left wall 606 can extend in a direction that is parallel to the y_{ROOM} axis 632 at width distance {x_{ROOM}=−3.5}. The boundary line 624 can be defined along the left wall 606 such that the inclusion zone 622 can extend between width distances {−3.5, 2.25}, and the exclusion zone 626 can extend between width distances {−5.75, −3.5}, measured along the x_{ROOM} axis 630. Accordingly, the first, second, third, and fourth persons 614A, 614B, 614C, 614D can be located in the inclusion zone 622, while the fifth and sixth persons 614E, 614F can be located in the exclusion zone 626.

As discussed above, if a person 614 is determined to be located within the inclusion zone 622, the data associated with the person 614 can be normally processed, and the person 614 may be properly framed or tracked using videoconference framing techniques. For example, a person can be normally processed and/or transmitted to a far end of the videoconference. Conversely, if a person 614 is determined to be located at least partially outside of the inclusion zone 622, data associated with the person may be filtered or blocked from being transmitted to a far end of the videoconference, and the person 614 may not be processed by videoconference framing or tracking techniques.

Therefore, the inclusion zone videoconferencing systems disclosed herein are capable of differentiating between data originating from within an inclusion zone and data originating from outside of an inclusion zone, wherein the zones are defined in terms of width and depth dimensions relative to a top-down view of the videoconference room or area. Correspondingly, the inclusion zone videoconferencing systems can prevent distracting movements and/or sound from being provided to a far end of a videoconference, which in turn may reduce confusion in the videoconference. In some aspects, the inclusion zone videoconferencing system disclosed herein are particularly advantageous in in open concept workspaces and/or conference rooms with transparent walls. Further, it is contemplated that FIGS. 6-12 illustrate non-limiting examples of inclusion zone videoconferencing systems, and that the inclusion zone videoconferencing systems may be applied to a variety of different conference rooms and are compatible with a variety of different camera arrangements.

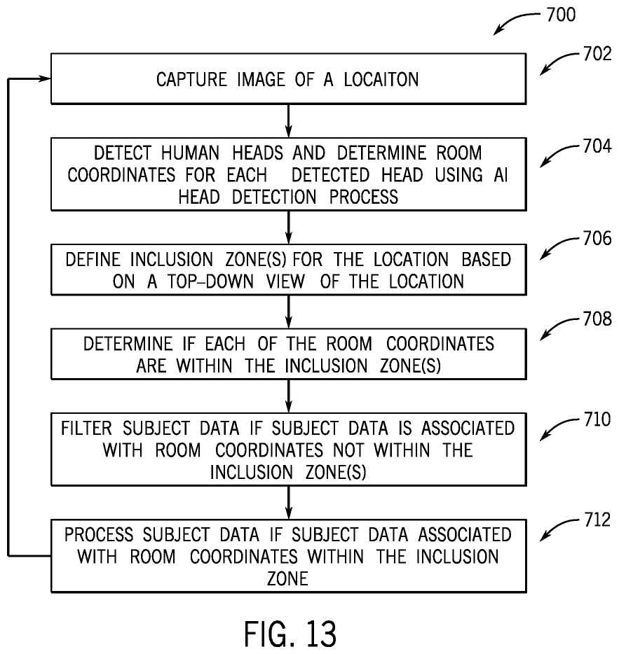

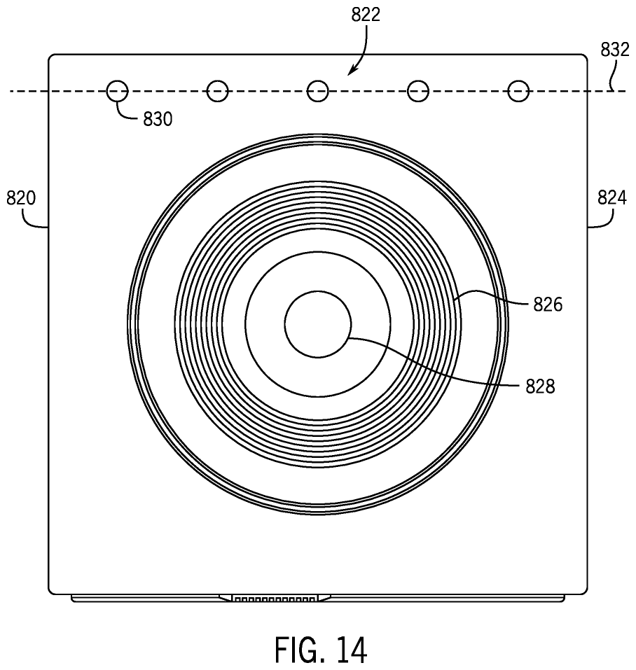

In light of the above, FIG. 13 illustrates a method 700 of implementing an inclusion zone videoconferencing system. At step 702 an image (or images) of a location is captured using a camera (or cameras). As discussed above, the camera can be arranged at a front of a conference room, and the camera can be in communication with and/or connected to a monitor and/or a codec that includes a memory and a processor, as will be discussed below in greater detail. At step 704, human heads in the images, i.e., heads of persons in the conference room, are detected using an AI head detection model, as described above. For example, the AI head detection model is applied to the image captured by the camera in order to generate, for each detected human head, a head bounding box with specified room and/or pixel coordinates. At step 706, an inclusion zone (or zones) is defined for the location based on a top-down view of the location, e.g., using world coordinates. The inclusion zone can be defined during a calibration phase, such as the automatic or manual calibration phases discussed above. Alternatively, if the inclusion zone was previously defined, step 706 can include retrieving previously set inclusion zone boundaries from memory.

At step 708, the system determines if the room coordinates and dimension information for each detected human head are within the boundaries of the inclusion zone. Put another way, the room coordinates of each detected human head are checked against the world coordinates of the inclusion zone to determine if any of the human heads are at least partially located outside of the inclusion zone. At step 710, the system filters subject data, i.e., data associated with or produced by a particular person in the location, if the subject data is determined not to have originated from within the inclusion zone. This can be accomplished using a variety of different filtering techniques such as, but not limited to, audio muting and video blurring, as discussed above. Additionally, in some applications, step 710 can further include filtering any data originating from outside the inclusion zone such as, for example, blurring all video outside the inclusion zone or muting any audio outside the inclusion zone even when subjects are not detected outside the inclusion zone. At step 712, the system processes subject data if the subject data is determined to have originated from within the inclusion zone. Processing subject data can include, for example, transmitting the subject data to a far end of the videoconference. Alternatively, subject data that is determined to have originated from within the inclusion zone can also be filtered before it is transmitted to a far end of the videoconference, though in a different manner than the subject data outside the inclusion zone. Operation returns to step 702 so that the differentiation between subject data originating from outside of the inclusion zone and subject data originating from within the inclusion zone is automatic as the camera captures images of the location.

Generally, the method 700 can be performed in real-time or near real-time. For example, in some aspects, the steps 702, 704, 706, 708, 710, 712, of the method 700 are repeated continuously or after a period of time has elapsed, such as, e.g., at least every 30 seconds, or at least every 15 seconds, or at least every 10 seconds, or at least every 5 seconds, or at least every 3 seconds, or at least every second, or at least every 0.5 seconds. Accordingly, the method 700 allows for tracking participants in real-time or near real-time, in a birds-eye view perspective, to determine whether the participants are in or out of the inclusion zone. It is contemplated that the entirety of the method 700 (including any of the other methods described above) may be performed within the camera, and/or the method 700 is executable via machine readable instructions stored on the codec and/or executed on the processing unit. Thus, it will be understood that the methods described herein may be computationally light-weight and may be performed entirely in the primary camera, thus reducing the need for a resource-heavy GPU and/or other specialized computational machinery.

FIG. 14 illustrates an example camera 820, which may be similar to the front camera 20, and an example microphone array 822, similar to microphone array 22 (see FIG. 1). The camera 820 has a housing 824 with a lens 826 provided in the center to operate with an imager 828. A series of microphone openings 830, such as five openings 830, are provided as ports to microphones in the microphone array 822. In some examples, the openings 830 form a horizontal line 832 to provide a desired angular determination for the SSL process, as discussed above. FIG. 14 is an example illustration of a camera 820, though numerous other configurations are possible, with varying camera lens and microphone configurations. Additionally, in some examples, aspects of the technology, including computerized implementations of methods according to the technology, can be implemented as a system, method, apparatus, or article of manufacture using standard programming or engineering techniques to produce software, firmware, hardware, machine readable instructions, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, the technology can be implemented as a set of instructions, tangibly embodied on a non-transitory computer-readable media, such that a processor device can implement the instructions based upon reading the instructions from the computer-readable media. Some examples of the technology can include (or utilize) a control device such as, e.g., an automation device, a special purpose or general-purpose computer including various computer hardware, software, firmware, and so on, consistent with the discussion below. As specific examples, a control device can include a processor, a microcontroller, a field-programmable gate array, a programmable logic controller, logic gates etc., and other suitable components for implementation of appropriate functionality (e.g., memory, communication systems, power sources, user interfaces and other inputs, etc.).

The above description assumes that the axes of front camera 20 and the microphone array 22 (see FIG. 1) are collocated. If the axes are displaced, the displacement is used in translating the determined sound angle from the microphone array 822 to the camera frames of reference.

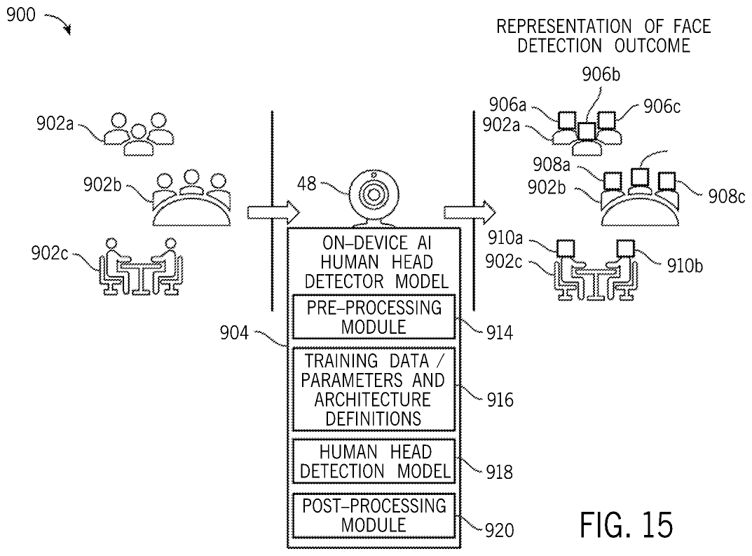

As described above, the methods of some aspects of the present disclosure include detecting a location of individual meeting participants using an AI human head detector model. Referring now to FIG. 15, an example process 900 is illustrated for determining coordinates of a detected human head using such an AI human head detector process. The AI human head detector process analyzes incoming room-view video frame images 902 of a meeting room scene with a machine-learning, AI human head detector model 904 to detect and display human heads with corresponding head bounding boxes 906, 908, 910. As depicted, each incoming room-view video frame image 902 may be captured by a front camera 20 in the video conferencing system. Each incoming room-view video frame image 902 may be processed with an on-device AI human head detector model 904 that may be located at the respective camera which captures the video frame images. However, in other examples, the AI human head detector model 904 may be located at a remote or centralized location, or at only a single camera. Wherever located, the AI human head detector model 904 may include a plurality of processing modules 912, 914, 916, 918 which implement a machine learning model that is trained to detect or classify human heads from the incoming video frame images, and to identify, for each detected human head, a head bounding box with specified image plane coordinate and dimension information.

In this example, the AI human head detector model 904 may include a first pre-processing module 912 that applies image pre-processing (such as color conversion, image scaling, image enhancement, image resizing, etc.) so that the input video frame image is prepared for subsequent AI processing. In addition, a second module 914 may include training data parameters and/or model architecture definitions which may be pre-defined and used to train and define the human head detection model 904 to accurately detect or classify human heads from the incoming video frame images. In selected examples, a human head detection model module 916 may be implemented as a model inference software or machine learning model, such as a Convolutional Neural Network (CNN) model that is specially trained for video codec operations to detect heads in an input image by generating pixel-wise locations for each detected head and by generating, for each detected head, a corresponding head bounding box which frames the detected head. Finally, the AI human head detector model 904 may include a post-processing module 918 which is applies image post-processing to the output from the AI human head detector model module 916 to make the processed images suitable for human viewing and understanding. In addition, the post-processing module 918 may also reduce the size of the data outputs generated by the human head detection model module 916, such as by consolidating or grouping a plurality of head bounding boxes or frames which are generated from a single meeting participant so that a single head bounding box or frame is specified.

Based on the results of the processing modules 912, 916, 918, the AI human head detector model 904 may generate output video frame images 902 in which the detected human heads are framed with corresponding head bounding boxes 906, 908, 910. As depicted, the first output video frame image 902a includes head bounding boxes 906a, 906b, and 906c which are superimposed around each detected human head. In addition, the second output video frame image 902b includes head bounding boxes 908a, 908b, and 908c which are superimposed around each detected human head, and the third output video frame image 902c includes head bounding boxes 910a, 910b which are superimposed around each detected human head. The AI human head detector model 904 may specify each head bounding box using any suitable pixel-based parameters, such as defining the x and y pixel coordinates of a head bounding box or frame in combination with the height and width dimensions of the head bounding box or frame. In addition, the AI human head detector model 904 may specify a distance measure between the camera location and the location of the detected human head using any suitable measurement technique. The AI human head detector model 904 may also compute, for each head bounding box, a corresponding confidence measure or score which quantifies the model's confidence that a human head is detected.

In some examples of the present disclosure, the AI human head detector model 904 may specify all head detections in a data structure that holds the coordinates of each detected human head along with their detection confidence. More specifically, the human head data structure for a number, n, of human heads may be generated as follows:

$$\{ \begin{matrix}{x}_{1} {y}_{1} {Width}_{1} {Height}_{1} {Score}_{1} \\ {x}_{2} {y}_{2} {Width}_{2} {Height}_{2} {Score}_{2} \\ … \\ {x}_{n} {y}_{n} {Width}_{n} {Height}_{n} {Score}_{n}\end{matrix} \}$$

In this example, xᵢ and yᵢ refer to the image plane coordinates of the i^{th} detected head, and where Widthᵢ and Heightᵢ refer to the width and height information for the head bounding box of the i^{th} detected head. In addition, Scoreᵢ is in the range [0, 100] and reflects confidence as a percentage for the i^{th} detected head. This data structure may be used as an input to various applications, such as framing, tracking, composing, recording, switching, reporting, encoding, etc. In this example data structure, the first detected head is in the image frame in a head bounding box located at pixel location parameters x₁, y₁ and extending laterally by Width₁ and vertically down by Height₁. In addition, the second detected head is in the image frame in a head bounding box located at pixel location parameters x₂, y₂ and extending laterally by Width₂ and vertically down by Height₂, and the n^{th} detected head is in the image frame in a head bounding box located at pixel location parameters xₙ, yₙ and extending laterally by Widthₙ and vertically down by Heightₙ. In some aspects, the center of each head bounding box is determined using the following equation:

$$( {x}_{i} + \frac{{w}_{i}}{2} , {y}_{i} + \frac{{h}_{i}}{2} ) .$$

This human head data structure may then be used as an input to the distance estimation process that takes the {Width, Height} parameters of each head bounding box to pick the best matching distance in terms of meeting room coordinates {x_{ROOM}, y_{ROOM}} from the look-up table (described above) by first using one of the Width or Height parameters with a first look-up table, and then using the other parameter as a tie breaking if multiple meeting room coordinates {x_{ROOM}, y_{ROOM}} are determined using the first parameter. The human head data structure itself may then be modified to also embed the distance information with each Head, resulting in a modified human head data structure that looks like the following:

$$\{ \begin{matrix}{x}_{1} {y}_{1} {Width}_{1} {Height}_{1} {Score}_{1} {x}_{1 {physical}_{room}} {y}_{1 {physical}_{room}} \\ {x}_{2} {y}_{2} {Width}_{2} {Height}_{2} {Score}_{2} {x}_{2 {physical}_{room}} {y}_{2 {physical}_{room}} \\ … \\ {x}_{n} {y}_{n} {Width}_{n} {Height}_{n} {Score}_{n} {x}_{{nphysical}_{room}} {y}_{{nphysical}_{room}}\end{matrix} \}$$

where {x_{ROOM1}, y_{ROOM1}}, {x_{ROOM2}, y_{ROOM2}}, . . . , {x_{ROOMn}, y_{ROOMn}} specify the distance of Head₁, Head₂, . . . , Headₙ, from the camera, respective, in two-dimensional coordinates.

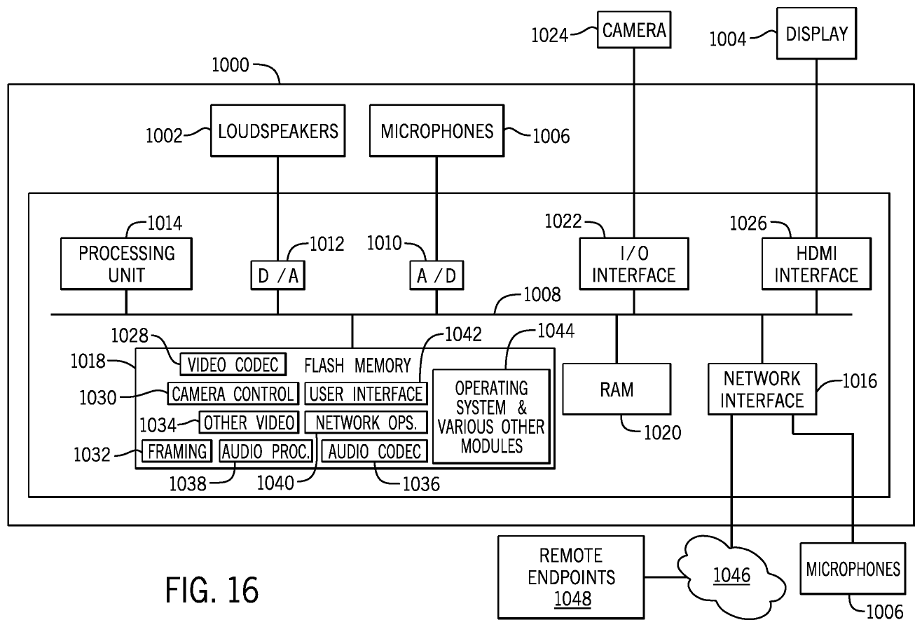

FIG. 16 illustrates aspects of a codec 1000 according to some examples of the present disclosure. As discussed above, a codec 1000 may be a separate device of a videoconferencing system or may be incorporated into the camera(s) within the videoconferencing system, such as a primary camera. Generally, the codec 1000 includes machine readable instructions to maintain a video call with a videoconferencing end point, receive streams from secondary cameras (and a primary camera if not integrated with the primary camera), and encode and composite the streams, according to the methods described herein, to send to the end point.

As shown in FIG. 16, the codec 1000 may include loudspeaker(s) 1002, though in many cases the loudspeaker 1002 is provided in the monitor 1004. The codec 1000 may include microphone(s) 1006 interfaced via a bus 1008. The microphones 1006 are connected through an analog to digital (AID) converter 1010, and the loudspeaker 1002 is connected through a digital to analog (D/A) converter 1012. The codec 1000 also includes a processing unit 1014, a network interface 1016, a flash or other non-transitory memory 1018, RAM 1020, and an input/output (I/O) general interface 1022, all coupled by a bus 1008. A camera 1024 is connected to the I/O general interface 1022. Microphone(s) 1006 are connected to the network interface 1016. An HDMI interface 1026 is connected to the bus 1008 and to the external display or monitor 1004. Bus 1008 is illustrative and any interconnect between the elements can used, such as Peripheral Component Interconnect Express (PCie) links and switches, Universal Serial Bus (USB) links and hubs, and combinations thereof. The camera 1024 and microphones 1006, 1006 can be contained in housings containing the other components or can be external and removable, connected by wired or wireless connections.

The processing unit 1014 can include digital signal processors (DSPs), central processing units (CPUs), graphics processing units (GPUs), dedicated hardware elements, such as neural network accelerators and hardware codecs.

The flash memory 1018 stores modules of varying functionality in the form of software and firmware, generically programs or machine readable instructions, for controlling the codec 1000. Illustrated modules include a video codec 1028, camera control 1030, framing 1032, other video processing 1034, audio codec 1036, audio processing 1038, network operations 1040, user interface 1042 and operating system, and various other modules 1044. In some examples, an AI head detector module is included with the modules included in the flash memory 1018. Furthermore, in some examples, machine readable instructions can be stored in the flash memory 1018 that cause the processing unit 1014 to carry out any of the methods described above. The RAM 1020 is used for storing any of the modules in the flash memory 1018 when the module is executing, storing video images of video streams and audio samples of audio streams and can be used for scratchpad operation of the processing unit 1014.

The network interface 1016 enables communications between the codec 1000 and other devices and can be wired, wireless or a combination. In one example, the network interface 1016 is connected or coupled to the Internet 1046 to communicate with remote endpoints 1048 in a videoconference. In one example, the general interface 1022 provides data transmission with local devices (not shown) such as a keyboard, mouse, printer, projector, display, exter-nal loudspeakers, additional cameras, and microphone pods, etc.

In one example, the camera 1024 and the microphones 1006 capture video and audio, respectively, in the videoconference environment and produce video and audio streams or signals transmitted through the bus 1008 to the processing unit 1014. As discussed herein, capturing “views” or “images” of a location may include capturing individual frames and/or frames within a video stream. For example, the camera 1024 may be instructed to continuously capture a particular view, e.g., images within a video stream, of a location for the duration of a videoconference. In one example of this disclosure, the processing unit 1014 processes the video and audio using processes in the modules stored in the flash memory 1018. Processed audio and video streams can be sent to and received from remote devices coupled to network interface 1016 and devices coupled to general interface 1022.

Microphones in the microphone array used for SSL can be used as the microphones providing speech to the far site, or separate microphones, such as microphone 1006, can be used.

Certain operations of methods according to the technology, or of systems executing those methods, can be represented schematically in the figures or otherwise discussed herein. Unless otherwise specified or limited, representation in the figures of particular operations in particular spatial order can not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular examples of the technology. Further, in some examples, certain operations can be executed in parallel, including by dedicated parallel processing devices, or separate computing devices that interoperate as part of a large system.

The disclosed technology is not limited in its application to the details of construction and the arrangement of components set forth in the following description or illustrated in the following drawings. Other examples of the disclosed technology are possible and examples described and/or illustrated here are capable of being practiced or of being carried out in various ways.

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in one example, the electronic based aspects of the disclosed technology can be implemented in software (for example, stored on non-transitory computer-readable medium) executable by a processor. Although certain drawings illustrate hardware and software located within particular devices, these depictions are for illustrative purposes. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computing device or can be distributed among different computing devices connected by a network or other suitable communication links.

Any suitable non-transitory computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, or a magnetic storage device. In the context of this disclosure, a computer-usable or computer-readable medium may be any medium that can contain, store, communicate, or transport the program for use by or in connection with the instruction execution system, apparatus, or device.

As used herein in the context of computer implementation, unless otherwise specified or limited, the terms “component,” “system,” “module,” “block,” and the like are intended to encompass part or all of computer-related systems that include hardware, software, a combination of hardware and software, or software in execution. For example, a component can be, but is not limited to being, a processor device, a process being executed (or executable) by a processor device, an object, an executable, a thread of execution, a computer program, or a computer. By way of illustration, both an application running on a computer and the computer can be a component. Components (or system, module, and so on) can reside within a process or thread of execution, can be localized on one computer, can be distributed between two or more computers or other processor devices, or can be included within another component (or system, module, and so on).

1. A method of using an inclusion zone for a videoconference, the method comprising:
capturing an image of a location;
applying a subject detector model to the image to identify room coordinates for each subject detected in the image;
defining the inclusion zone for the location, the inclusion zone based on a top-down view of the location;
determining if the room coordinates for each subject are within the inclusion zone;
filtering data associated with subjects that are determined to be not within the inclusion zone; and
processing data associated with subjects that are determined to be within the inclusion zone.

2. The method of claim 1, wherein capturing images of the location includes capturing images of a portion of an enclosed room or a portion of an open concept workspace.

3. The method of claim 1, wherein applying the subject detector model includes defining bounding boxes for each human head of each subject that is detected in the image.

4. The method of claim 1, wherein defining the inclusion zone further includes manually inputting room coordinates of the inclusion zone during a manual calibration phase using a graphical user interface.

5. The method of claim 1, wherein defining the inclusion zone further includes recording world coordinates of a subject during a calibration phase to create boundary lines of the inclusion zone.

6. The method of claim 5, wherein defining the inclusion zone further includes determining, in an automatic calibration phase, maximum and minimum room parameters of the location.

7. The method of claim 6, wherein that maximum and minimum room parameters include a maximum room width parameter, a minimum room width parameter, and a maximum room depth parameter.

8. The method of claim 1, wherein filtering the data associated with subjects that are determined to be not within the inclusion zone includes at least one of:
muting audio included in the data; and
blurring video included in the data.

9. The method of claim 1, wherein processing the data includes transmitting the data to a far end of the videoconference.

10. A videoconferencing system using an inclusion zone, the system comprising:
a camera to capture an image of a location;
a microphone to receive sound;
a processor connected to the camera and the microphone, the processor to execute a program to perform videoconferencing operations including transmitting data to a far end videoconferencing site; and
a memory coupled to the processor, the memory storing instructions that, when executed by the processor, cause the processor to:
identify room coordinates for each subject that is detected in the image;
define the inclusion zone for the location, the inclusion zone based on a top-down view of the location;
determine if the room coordinates for each subject are within the inclusion zone;
filter data associated with subjects that are determined to be not within the inclusion zone; and
process data associated with subjects that are determined to be within the inclusion zone.

11. The system of claim 10, wherein the processor to identify the room coordinates for each subject that is detected in the image includes the processor to define bounding boxes for each human head of each subject that is detected in the image.

12. The system of claim 10, wherein the processor to define the inclusion zone further includes the processor to use manually input room coordinates of the inclusion zone during a manual calibration phase via a graphical user interface.

13. The system of claim 10, wherein the processor to define an inclusion zone for the location includes, the processor to use the camera to record world coordinates of a subject during a calibration phase to create boundary lines of the inclusion zone.

14. The system of claim 13, wherein the processor to define the inclusion zone further includes the processor to determine, in an automatic calibration phase, maximum and minimum room parameters of the location.

15. The system of claim 10, wherein the processor to filter the data associated with subjects that are determined to be not within the inclusion zone includes at least one of the processor to:
mute audio included in the data; and
blur video included in the data.

16. The system of claim 10, wherein the processor to process the data includes the processor to transmit the data to the far end videoconferencing site.

17. The system of claim 10, wherein the processor is further caused to define a virtual boundary line separates the inclusion zone from an exclusion zone.

18. The system of claim 17, wherein data in the inclusion zone is processed differently from data in the exclusion zone.

19. A non-transitory computer-readable medium containing instructions that when executed cause a processor to:
instruct a camera to capture an image of a location;
apply a machine learning human head detector model to the image to detect human heads in the image and identify coordinates for each human head detected;
define an inclusion zone for the image based on a top-down view of the location; and
determine if each human head detected is located within the inclusion zone.

20. The non-transitory computer-readable medium of claim 19, wherein the processor is further to:
filter data associated with subjects that are determined to be not within the inclusion zone; and
process data associated with subjects that are determined to be within the inclusion zone.
